(19) United States
(12) Patent Application Publication
(10) Pub. No.: US 2002/0124061 A1
(43) Pub. Date: Sep. 5, 2002

(54) Configuration system and method

(76) Inventor: Paul Mossman, Ottawa (CA)

Correspondence Address: Robert Feutlinske, KIRBY EADES GALE BAKER, P. O. Box 3432, Station D, Ottawa, ON, K1P 6N9, CA

(21) Appl. No.: 09/749,779

(22) Filed: Dec. 28, 2000

Related U.S. Application Data
(60) Provisional application No. 60/252,920, filed on Nov. 27, 2000.

(51) Int. Cl. G06F 15/173

(52) U.S. Cl. 709/220; 709/224

(57) ABSTRACT

A model is provided for embedding complex operation, administration and maintenance (OAM) interface business rules in a system in a manner that enables the system to effectively perform collection and batch-mode application of transactions through complex OAM interfaces. The configuration method for collection and batch-mode application of transactions defined by settings for a target system having an operation, administration and maintenance (OAM) interface includes the following steps: constructing a virtual representation in a software model of the target system, where the virtual representation emulates the OAM interface of the target system; providing collection tools to interact with the virtual representation of the target system to establish values for the plurality of settings; and applying the established values for settings to the target system in a batch-mode. The configuration system and method will permit more effective implementations of user-friendly task-flow (i.e. wizard) programming. Further, configurations that apply to multiple complex systems can be created, and then delivered to those systems in a scheduled manner.

### CROSS REFERENCE TO RELATED APPLICATION

This application claims the benefit of U.S. provisional application No. 60/______ filed Nov. 27, 2000 entitled “Configuration System and Method”.

### FIELD OF THE INVENTION

The present invention relates generally to the field of configuration systems, and more particularly in the field of collection and batch-mode application of transactions through complex interfaces such as in communication system configuration and complex system configuration in policy managed network environments.

### BACKGROUND OF THE INVENTION

Collection of transactions to apply in a batch-mode through complex OAM (operation, administration and maintenance) interfaces presents many difficulties in current complex system environments. The difficulties arise in evaluating whether or not various settings in the system should be made visible (to a user/operator) and in validating the options selected for each visible setting. The system collecting the settings must be aware of the business rules that are to be enforced concerning the visibility and valid options of each setting. For example, setting A is only applicable when setting B is “N”. Therefore, setting A should only be presented to the user when setting B is, or will be, set to “N”. Embedding this knowledge in a collection system has proven difficult in prior art configuration systems.

Additionally, the system that performs the application of the settings must perform this application in correct order. Therefore, the application system must also be aware of the business rules that will be enforced. For example, setting A must be set to Pool C and setting B must be set to Y, but Pool C is a valid option for A only when B is set to Y. Setting B must be set to Y before an attempt is made to set setting A to Pool C. Embedding this additional knowledge in an application system has also proven difficult.

An example application for the present invention involves the field of communication and telephony systems. Communication systems can have thousands of configuration parameters that can be set to optimize the system for its intended purpose. Some of these configuration parameters must necessarily be set for the system to operate while others are merely function optimization options and are not crucial to the operation of the system. While the function optimization options may be ignored during system configuration, setting these parameters according to the manner in which the system will be used can enhance the system. However, these parameters can be overlooked during system configuration among the many other settings.

Typically, configuring a system in a batch-mode occurs in two phases: data collection and data application. These phases are often closely integrated with a single data collection process followed immediately by a data application process to apply the collected data and then again by another collection process. This creates inefficiencies when configuring a system as general front-end parameters must first be set and established on the system before access to lower level, more detailed sub-parameters can be gained (termed visibility). Validity (i.e. providing correct options to a user) and wait time are also factors that can contribute to inefficiencies in configuring a system. When the time to set certain parameters is on the order of many minutes configuring a system becomes a very time consuming task.

Consequently, there is a need for a configuration system and method that allows for rapid and intuitive system configuration. Further, there is a need for a configuration system and method and will succeed when collected transactions are ultimately applied to the actual system being configured.

### SUMMARY OF THE INVENTION

In accordance with an aspect of the present invention there is provided an apparatus for configuring a plurality of parameters of a target system having an interface. The apparatus comprising: (a) a virtual system hosted on a computer, said virtual system including: (i) a collection tool supporting the interface of the target system, wherein changes to the plurality of parameters are applied to the virtual system; and (ii) an application tool for applying the changes of the plurality of parameters in a batch-mode to the target system. The apparatus further including an interface to the virtual system interacting with the collection tool of the virtual system to enable changes to the plurality of parameter to be communicated to the collection tool, wherein the changes to the plurality of parameters are cumulated prior to application to the target system by the application tool.

In accordance with another aspect of the present invention there is provided a computer-readable medium having stored thereon computer executable instructions for configuring a plurality of parameters of a target system having an interface. The instructions include: (a) providing a virtual system to emulate behavior of the target system as defined by the interface of the target system; (b) collecting and validating at least one change to the plurality of parameters by application to the virtual system; and (c) applying the at least one change of the plurality of parameters in a batch-mode to the target system.

In accordance with another aspect of the present invention there is provided, in a computer system, a method of creating a program using a graphical user interface for configuring a plurality of parameters of a target system having an interface. The method comprising the steps of: (a) providing a virtual system to emulate behavior of the target system as defined by the interface of the target system; (b) collecting through the graphical user interface and validating at least one change to the plurality of parameters by application to the virtual system; and (c) applying the at least one change of the plurality of parameters in a batch-mode to the target system.

In accordance with another aspect of the present invention there is provided a configuration apparatus for collection and batch-mode application of transactions defined by a plurality of settings for a target system having an operation, administration and maintenance (OAM) interface. The apparatus includes: (a) a virtual system having a host computer programmed to emulate functionality of the target system; (b) a collection system interacting with the virtual system for establishing values for the plurality of settings; and (c) an application system for applying the established values for the plurality of settings to the target system in a batch-mode.

In accordance with another aspect of the present invention there is provided a configuration method for collection and batch-mode application of transactions defined by a plurality of settings for a target system having an operation, administration and maintenance (OAM) interface. The method comprising the steps of: (a) constructing a virtual representation in a software model of the target system; (b) providing collection tools to interact with the virtual representation of the target system to establish values for the plurality of settings; and (c) applying the established values for the plurality of settings to the target system in a batch-mode.

In accordance with an exemplary aspect of the present invention a model (implemented in a system or a method) is provided for embedding complex OAM interface business rules in a system in a manner that enables the system to effectively perform collection and batch-mode application of transactions through complex OAM interfaces.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Further features and advantages of the present invention will be described in the detailed description, taken in combination with the appended drawings, in which:

FIG. 1 illustrates a block diagram of an environment incorporating a configuration system according to an embodiment of the present invention;

FIG. 2 illustrates a state diagram of the virtual system and interface of the configuration system shown in FIG. 1;

FIG. 3 illustrates an expanded block diagram of FIG. 1 expanding on the virtual system;

FIG. 4 illustrates a state diagram of a configuration instance used the configuration system of FIG. 1;

FIG. 5 illustrates a configuration system exemplifying a specific implementation of the present invention using Internet tools;

FIG. 6 illustrates a block diagram representation of the virtual system shown in FIG. 5 according to an exemplary embodiment;

FIG. 7 illustrates a sample data page of a configuration instance;

FIG. 8 illustrates a plurality of trees embodied in the virtual system shown in FIG. 7;

FIGS. 9A, 9B, 9C and 9D illustrate screen shots of sample configuration instances; and

FIGS. 10A, 10B, 10C and 10D illustrate sequence diagrams of the configuration method of the present invention applied to an ATM (automatic teller machine)/CBS (central banking system) environment.

### DETAILED DESCRIPTION OF EMBODIMENTS OF THE PRESENT INVENTION

In the present application the term “system” is generally defined as including any system that includes a complex interface. Interfaces are considered complex when certain settings and operations have effects on other settings or operations. Examples include communication systems, banking systems and the like.

A communication system is generally defined as a machine with intelligence that does communication tasks (e.g. telephony servers used to control, add intelligence, store, forward and manipulate the various voice, data, fax and email calls flowing into and out of a system). A traditional function of a telephony server is to move call control commands from clients on a LAN (local area network) to an attached PBX (private branch exchange) or ACD (automatic call distributor). A telephony server can also be a voice response system, a fax on demand system and a conferencing device or switch.

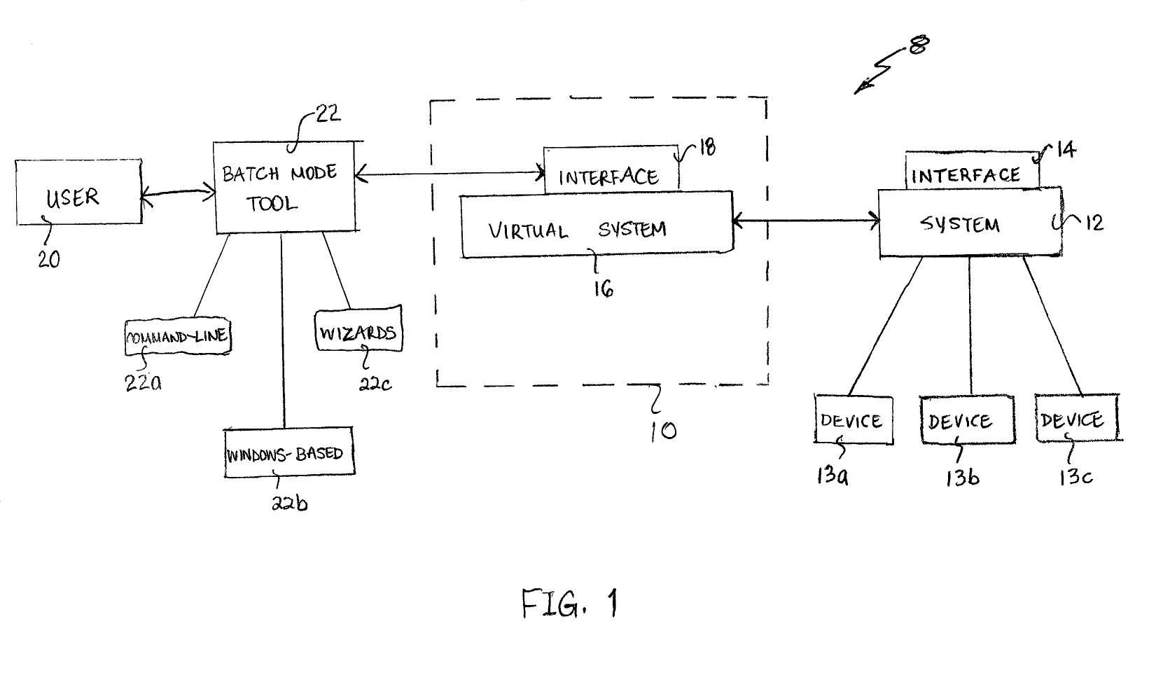

FIG. 1 provides a general block diagram illustration of an environment 8 incorporating a configuration system 10 according to the present invention. For a system 12, controlling a plurality of devices 13a-c, with an interface 14 (e.g. a complex OAM-operation, administration and maintenance based interface); the present invention specifies the creation of a virtual system 16, which supports an interface 18. A user 20 interacts with a batch-mode tool 22 (e.g. command-line 22a, windows-based 22b or wizards 22c) to control the virtual system 16 through the interface 18. The interface 18 effectively enables the delivery/interaction of the tool 22 with the system 12.

The interface 18 of the virtual system 16 can be identical to the interface 14 of the system 12, or it can be a similar (i.e. simplified or enhanced) version of interface 14. The virtual system 16 mimics the system 12, but not its main functionality. A responsibility of the virtual system 16 is to replicate the behavior of the system 12, as seen through interface 18. The virtual system 16 contains and enforces business rules of the system 12. Proper replication of the OAM behavior of the system 12 ensures that the virtual system 16 collects changes applied through the interface 14, the only exceptions being changes that have no effect (e.g. returning a setting value to its previous value) or changes that have been cancelled.

Collection is achieved by applying changes directly to the virtual system 16, as if those changes were being immediately applied to the system 12 directly. This allows the virtual system 16 to perform a collection or aggregation phase that presents the correct settings when appropriate and effectively verifies the selections made by the user 20 to enable configuration of the system 12.

Applying changes to the virtual system 16, in contrast to the system 12 directly, provides the following advantages:

(i) changes that take time to complete on the actual system 12 are cumulated and delayed until a complete configuration of the system 12 is ready;

(ii) changes applied to the virtual system 16 will not (at least immediately) cause changes or instability on the actual system 12; and

(iii) the activity of applying changes to the virtual system 16 does not necessarily require a connection to the actual system 12.

Another responsibility of the virtual system 16 is to apply the collected changes to the actual system 12 in a batch/application mode (after completion of the collection phase). Therefore, since the virtual system 16 mimics the system 12, the virtual system 16 has knowledge of the correct order that the changes should be applied to the system 12.

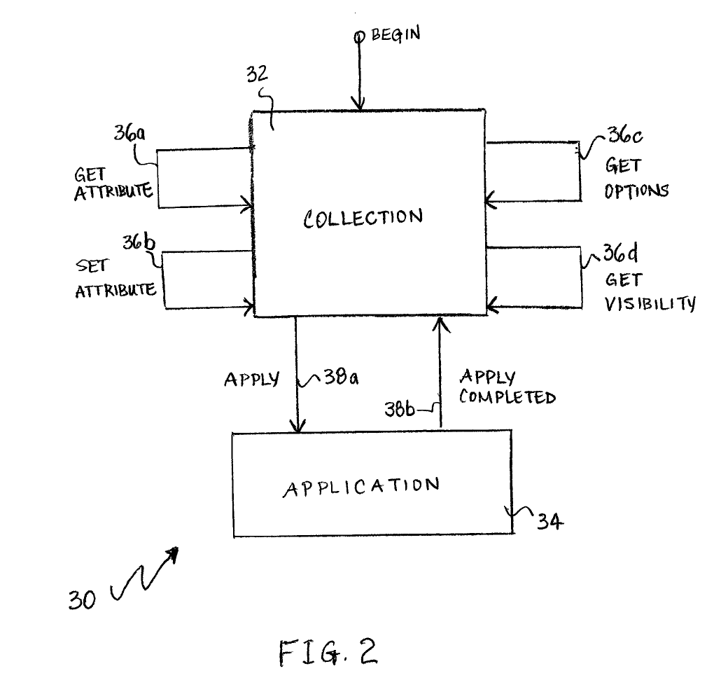

The concepts of collection, application and order are discussed in FIG. 2, which illustrates a state machine 30 representation of the virtual system 16 and interface 18. The state machine 30 includes a collection operation 32 and an application operation 34. Within the collection operation 32 the following functions are provided: get attribute 36a, set attribute 36b, get options 36c and get visibility 36d. Between the collection operation 32 and the application operation 34 the following functions are provided: apply 38a and apply completed 38b, which are functions that both interfaces 18 and 14 support. Some specific examples are:

Banking

(a) to pay a bill X for Y$ from a savings account at an automatic teller machine—the set attribute function 36b would be “set attribute (pay-invoke, X, Y$, savings)” and the get options function 36c would be “get options (bill payment)”;

(b) to obtain a balance for a savings account—the get attribute function 36b would be “get attribute (balance, savings)”; and

(c) to withdraw Y$ from a savings account—the set attribute function 36b would be “set attribute (withdrawal-invoke, Y$, savings).

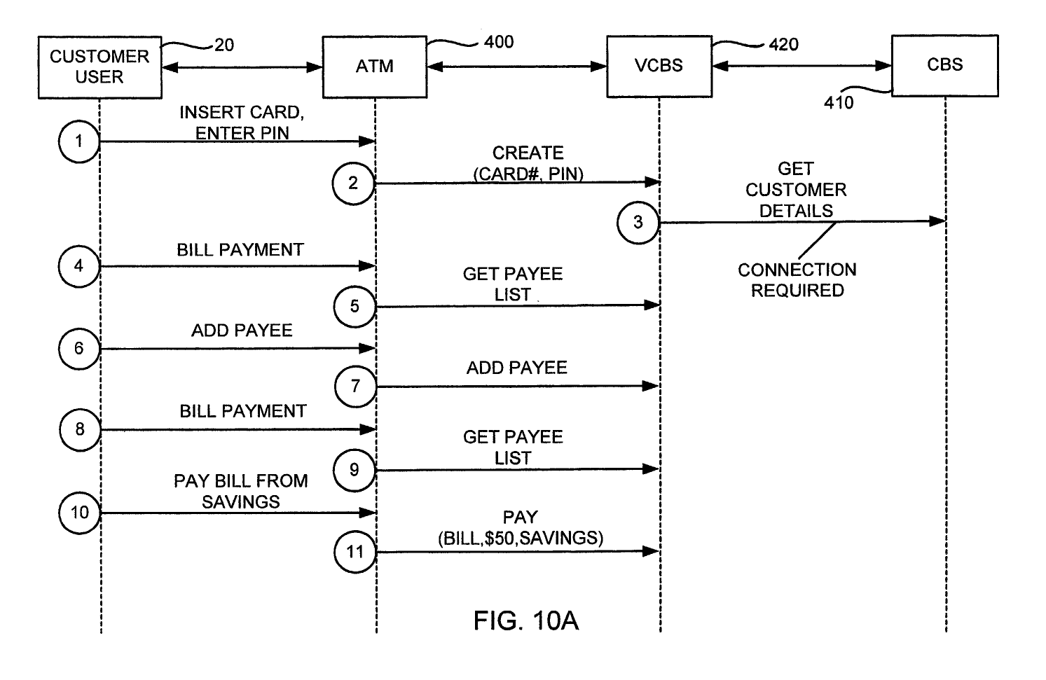

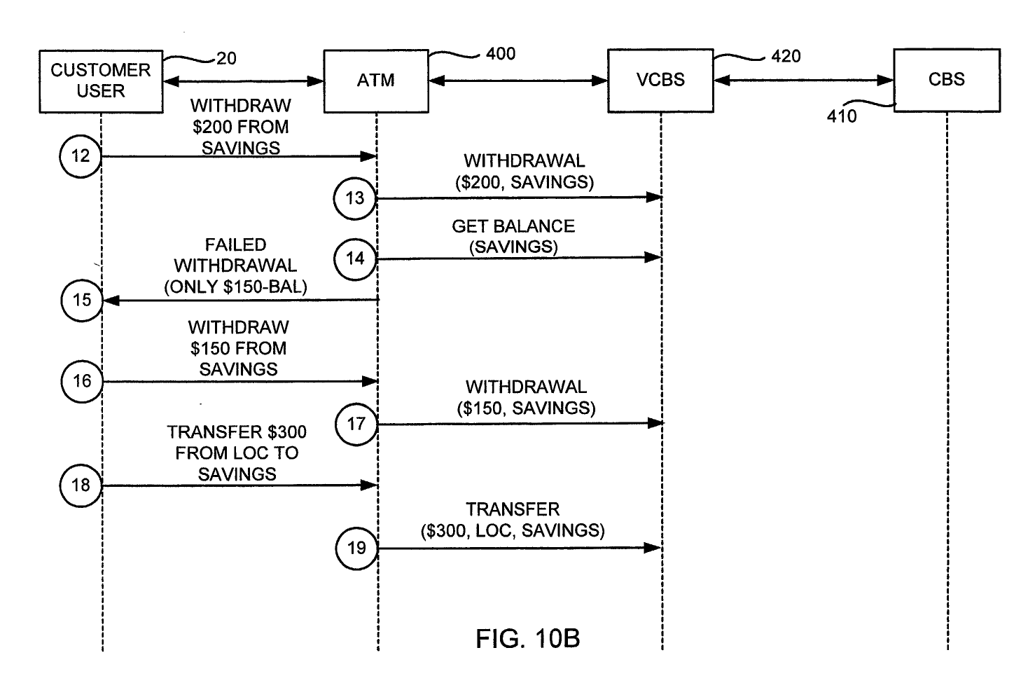

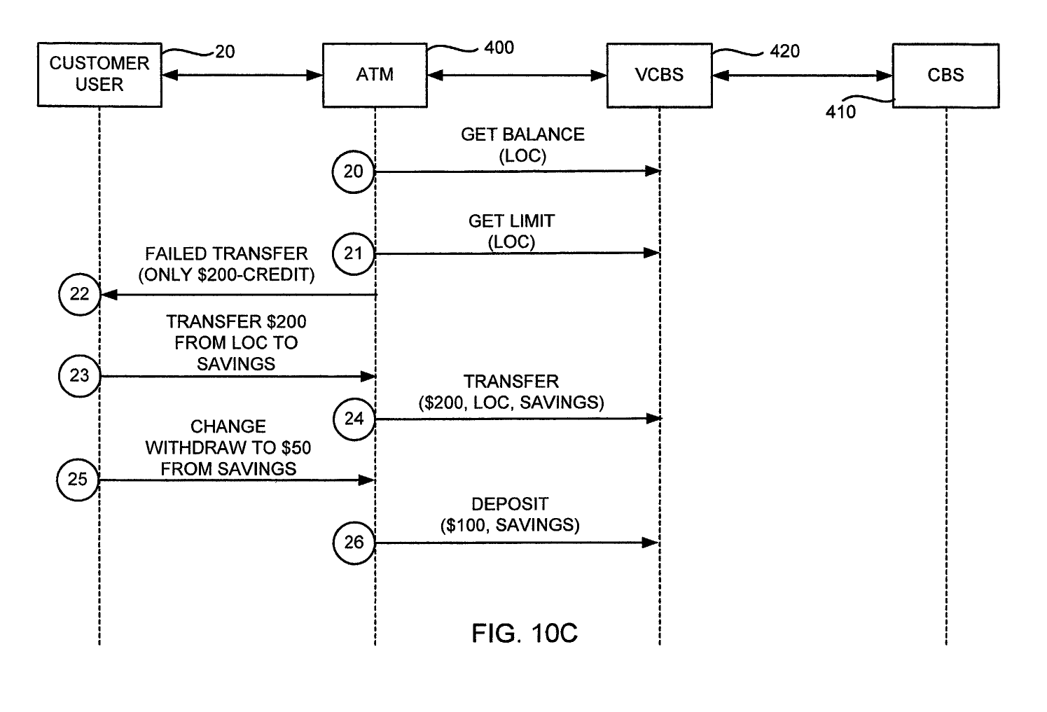

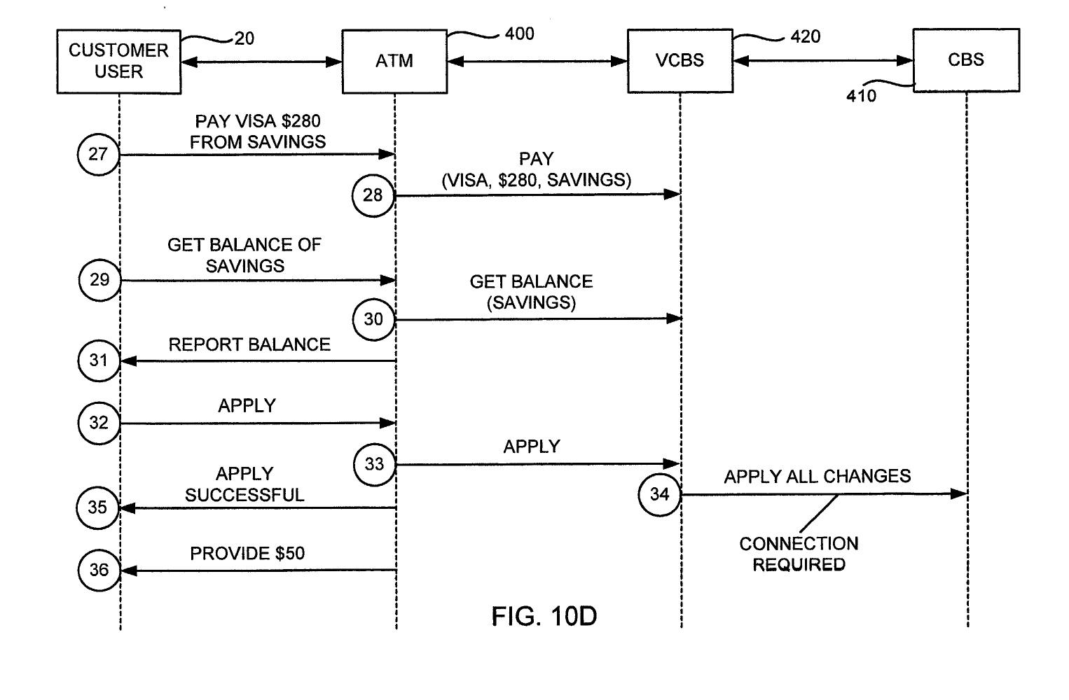

Further discussion of the banking example above is provided in the discussion of FIGS. 10A-10D.

VMIS (Java™) Example

(a) VMIS_GetChildren (path, type)—the get attribute function 36a would be “get attribute (child_list, path, type);

(b) VMIS_GetName (path, type)—the get attribute function 36a would be “get attribute (name, path, type);

(c) VMIS Add (path, add input (child name), type)—the set attribute function 36b would be “set attribute (new child, path, child name, type); and

(d) VMIS_GetValue (path, type)—the get attribute function 36a would be “get attribute (value, path, type).

Example E1 describes a group of related settings used to configure the system 12 (in this example a telephony system) and how the configuration system 10 of the present invention is used to perform effective batch-mode configuration of these options.

### EXAMPLE E1

Number dialing that is automatically attempted when a telephone's handset (i.e. one of the devices 13a-c) is removed from the cradle is termed a “hotline”. This feature is generally configured with the following settings:

1. hotline type;

2. internal number (No.);

3. external number (No.); and

4. external facility.

Different configurations make use of different combinations of the settings. For many of the settings there exists a configuration in which a particular setting is not applicable and is considered “not visible”. Different configurations of other parts of the system 12 also affect the range of valid options for various settings. Table E1 provides examples of various visibility and valid options for each hotline setting.

TABLE E1

| SETTING | VALID OPTION(S) | VISIBILITY |
|---|---|---|
| type | none, internal, external | always visible |
| internal No. | one of the DNs in the system 12, except | visible only when |
| | for the DN that applies to the present set | the “type” |
| | (i.e. the set being programmed). A | setting is set |
| | hotline will never dial itself. | to “internal” |
| external | termed the “prime line” or one of the | visible only when |
| facility | lines assigned to the set, or one of the | the “type” |
| | pools assigned to the set | setting is set |
| | | to “external” |
| external No. | a dialing string, 0-25 characters | visible only |
| | | when the “type” |
| | | setting is set |
| | | to “external” |

The configuration system 10 of the present invention overcomes difficulties in configuring the system 12 in a batch-mode caused by the dynamic visibility and dynamic options of the settings. Examples of difficulties are: (1) evaluating the settings that should be collected for a desired configuration (e.g. an external No. should not be collected if the type setting is internal); (2) offering appropriate options (e.g. for the external facility setting, processing is required to determine what options should be displayed); and (3) applying these settings to the system 12 in the correct order (e.g. the internal No. setting should not be configured until the “type” setting is set to “internal”, otherwise the system 12 may reject any “internal No.” value.).

The configuration system 10 enables the effective delivery of the batch-mode tool 22 used to aid in configuring the settings. Examples of tools (see FIG. 1) are: (a) batch-mode command-line tool 22a; (b) batch-mode windows-based tool 22b; and (c) wizard-like tool 22c. Each tool has knowledge of the existence of the four settings for the “hotline” example above, but is not required to deal with the batch-mode functions.

In particular, each of the tools 22a-c (for example) use the interface 18 of the virtual system 16 in the following manner:

(1) For each setting (four in the case of the “hotline” example E1):

(a) query the virtual system 16 to determine if a particular setting is currently visible; and

(b) if setting is visible:

(i) obtain current value of the setting and a valid option specification and

(ii) make the setting, with the option specification, available for user-manipulation.

(2) If the user makes a change to a visible setting:

(a) send the change to the interface 18 of the virtual system 16; and

(b) return to step (1).

(3) If current settings are satisfactory (as determined by the user 20) then instruct the interface 18 of the virtual system 16 to apply the settings to the actual system 12.

The interface 18 of the virtual system 16 is programmed to be aware of the settings that are applicable in the current configuration. After each setting update, the tool 22 queries to the interface 18 to determine if any of the settings have changed visibility.

The interface 18 of the virtual system 16 constructs the appropriate valid option specifications. The tool 22 presents the options and double-checks the user 20 selections with the interface 18.

The interface 18 of the virtual system 16 mimics the interface 14 (visibility and valid option) behavior of the actual system 12. This forces the tool 22 to only allow the configuration selections (also termed transactions) to be made in an order that is valid when the interface 18 applies the transactions to the actual system 12.

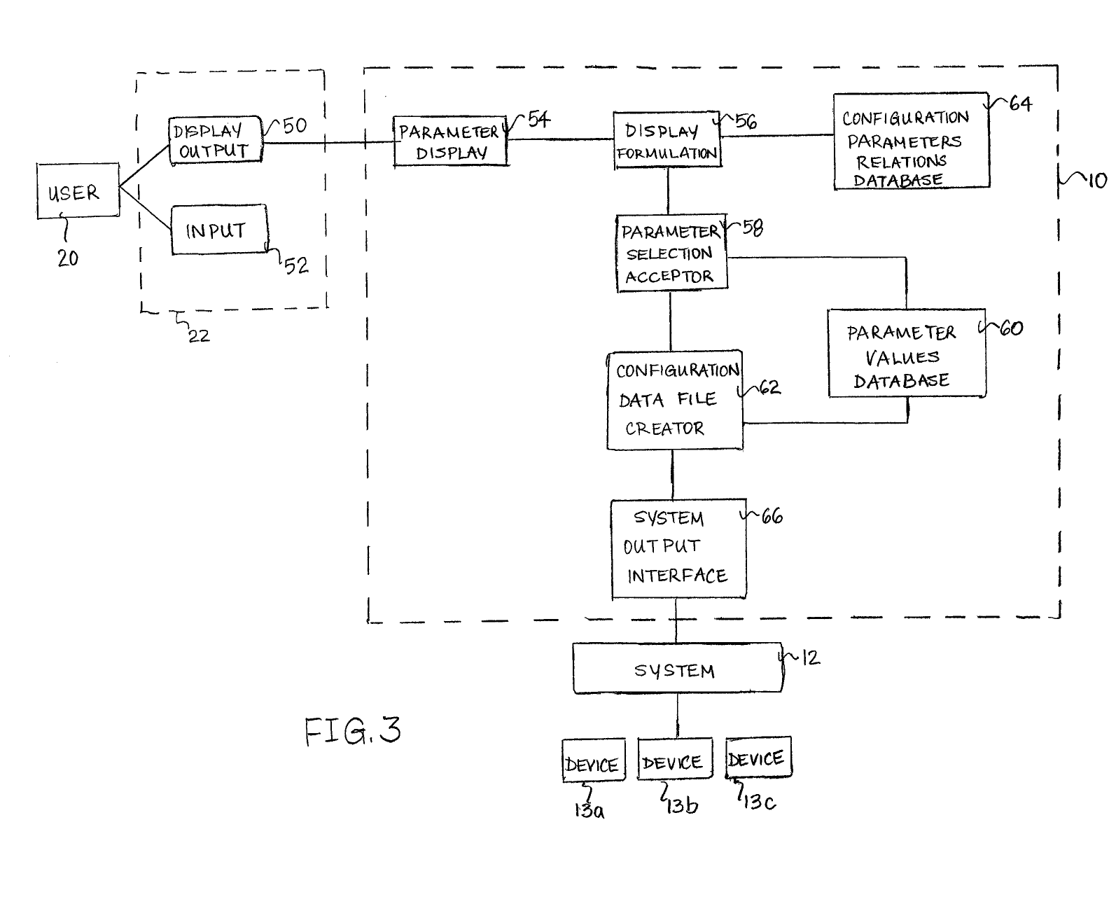

FIG. 3 illustrates an overall view of the configuration system 10 used to establish and apply transactions for the system 12. The user 20 interacts with the configuration system 10 through the batch-mode tool 22, which includes a display output 50 and an input module 52. The display output 50 presents a representation of operating parameters for the system 12 based on content depiction provided by a parameter display module 54 and a display formulation module 56.

The user 20 can select or provide input on the displayed representation of operating parameters through the input module 52. User input is provided to a parameter selection acceptor 58 where the type of data provided is processed. If the user input pertains to information display flow then the display formulation module 56 is informed of requested changes. If values are provided for specific operating parameters these values are stored in a parameter values database 60 where they may be extracted at a later time.

As certain parameter values may alter information display flow, the display formulation module 56 is notified of parameter value changes. If the user input is a command to execute a configuration on the system 12 then a configuration data file creator 62 initiates this process.

The display formulation module 56 manipulates the information that is displayed according to previously received instructions such as display flow commands and parameter values. Based on operating parameter values the display formulation module 56 consults a configuration parameters relations (CPR) database 64 to determine the corresponding parameters that still require configuration or must be correspondingly changed. The configuration parameters relations database 64 contains a hierarchical list of the operating parameters of the system 12 according to their relations to each other.

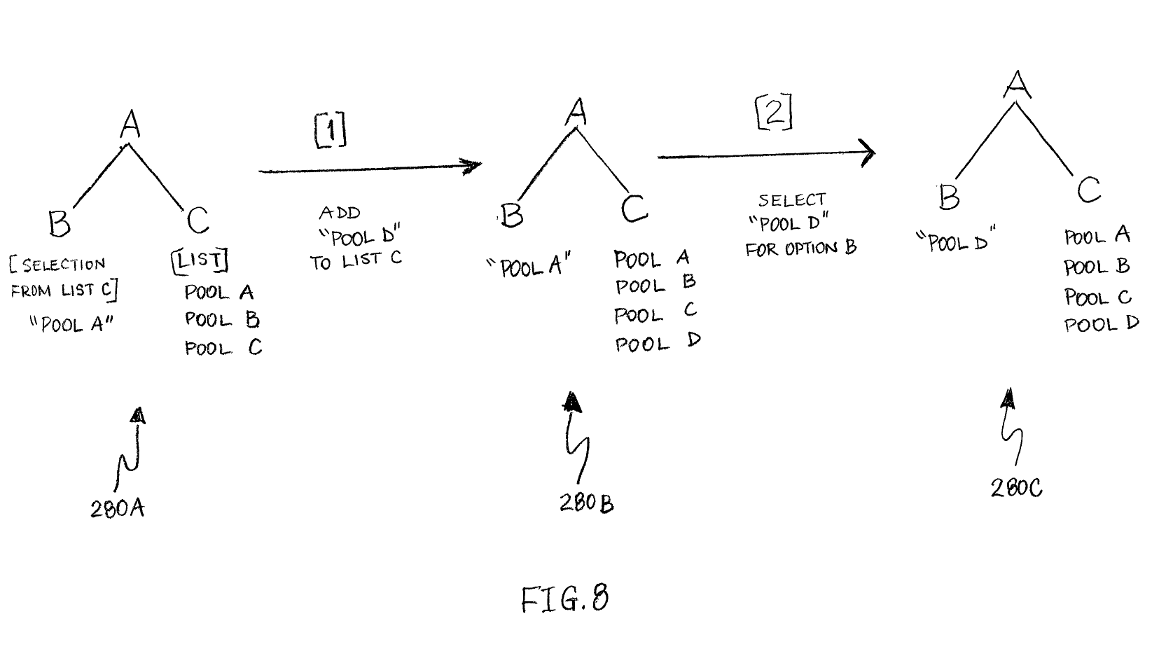

For example, certain parameters can only be set when other parameters have been given a certain value. The configuration parameter relations database 64 represents the relations between parameters in a tree format (example provided in FIG. 8) where a certain value for one parameter leads to a second parameter being set. The display formulation module 56 only presents those operating parameters that are relevant, or can be set, to the parameter display module 54. The parameter display 54 accepts a series of operating parameters to be displayed and formats a display that is sent to the display output 50.

The operating parameters may be displayed in such a manner as to present the user 20 not only with a series of parameters requiring values but with a representation of the parameters that allows for easier understanding of their purpose and hence a system configuration more optimized for its intended purpose. That is, the display output 50 may only present those parameters that are able to be or need to be configured based on the values of previously set operating parameters.

To allow for the configuration system 10 to follow the business requirements of the user 20, the configuration parameter relations database 64 may also store high level categorical relations between the operating parameters. These high-level categorical relations may be defined such that selection of a category by the user 20 may allow multiple operating parameters to be defined.

When a command to execute a configuration on the system 12 is received or the display formulation module 56 detects that the end of a hierarchical list in the configuration parameter relations database 64 has been reached then the configuration data file creator 62 forms a data file for configuring the system 12. The data file is formed from the parameter values database 60. This data file is used by a system output interface 66 to configure the system 12.

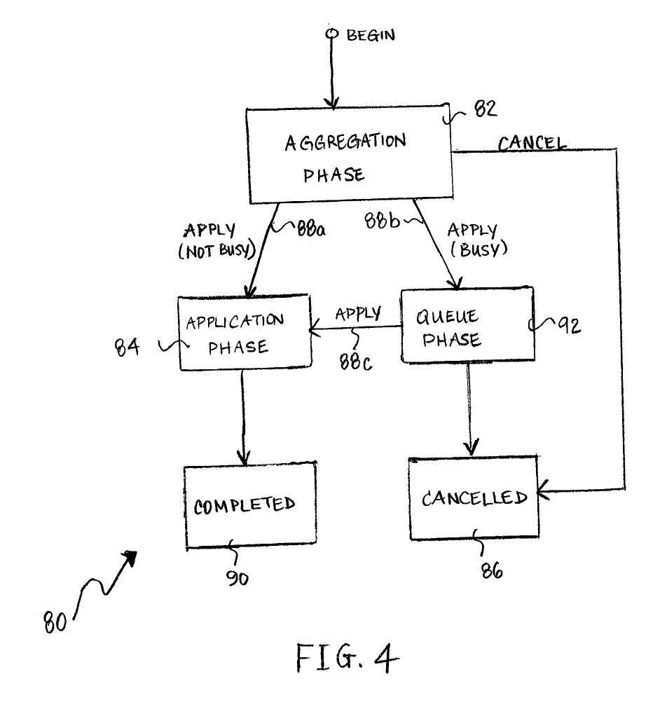

FIGS. 4 to 6 provide a specific illustrative example of a configuration system and method according to the present invention using specific tools 22b, c in an Internet based environment.

FIG. 4 shows a state diagram to illustrate a configuration instance 80 to explain the operation of the configuration system 10 according to an illustrative example of the present invention. The configuration instance 80 is executed in two phases: an aggregation phase 82 and an application phase 84. The aggregation phase 82 is an interactive state in which data to be applied to the system 12 is collected from the user 20 and stored in the parameters values database 60. For example, a graphical user interface (GUI) is displayed in display output 50 to the user 20 using information from the configuration parameter relations database 64 and formatted by the display formulation module 56 and the parameter display 54. The GUI display of information facilitates the collection of data, handled by the parameter selection module 58, that will be applied to accomplish the programming task.

A summary page of data is created by the display formulation module 56 and by the parameter display module 54 at the end of the aggregation phase 82. The summary page is created when the display formulation module 56 detects that the last parameter in a hierarchical list in the configuration parameter relations database 64 has been set. Alternatively, the summary page may be created when the parameter selection module 58 detects a request from the user 20 to finish the aggregation phase 82.

At any point in the aggregation phase 82, the configuration instance 80 can be cancelled without causing programming changes to the system 12 by moving from the aggregation phase 82 directly to a cancelled state 86. The summary page includes an “apply” option (88a when application phase 84 is not busy, 88b when the application phase 84 is busy, and 88c when applied after queuing discussed further below), which leads to the application phase 84. In preparation for exiting the aggregation phase 82 and starting the application phase 84, the configuration data file creator 62 creates a file for configuring the system 12 containing the data collected in the parameter values database 60 during the aggregation phase 82.

Once the aggregation phase 82 has ended, the configuration instance 80 ends communication with the user 20. The application phase 84 is a non-iterative state in which the aggregated data is applied to the system 12 as discussed above in conjunction with FIG. 2. The application phase 84 runs until it completes, fails or is stopped resulting in passage to a completed state 90. When the configuration instance 80 is completed, the user 20 can view the status of the completed task through the display output 50.

When a configuration instance 80 exits the aggregation phase 82, it generally proceeds (after being “applied” 88a) directly to the application phase 84. The only exception occurs when another configuration instance 80 is in the application phase 84. In this case, the configuration instance 80 is queued (apply when busy 88b) in a queue phase 92 for ultimate application (apply 88c) to the application phase 84. More than one configuration instance 80 may be in the queue phase 92 at any given time. Queued configuration instances 80 can also be cancelled with passage to the cancelled state 86.

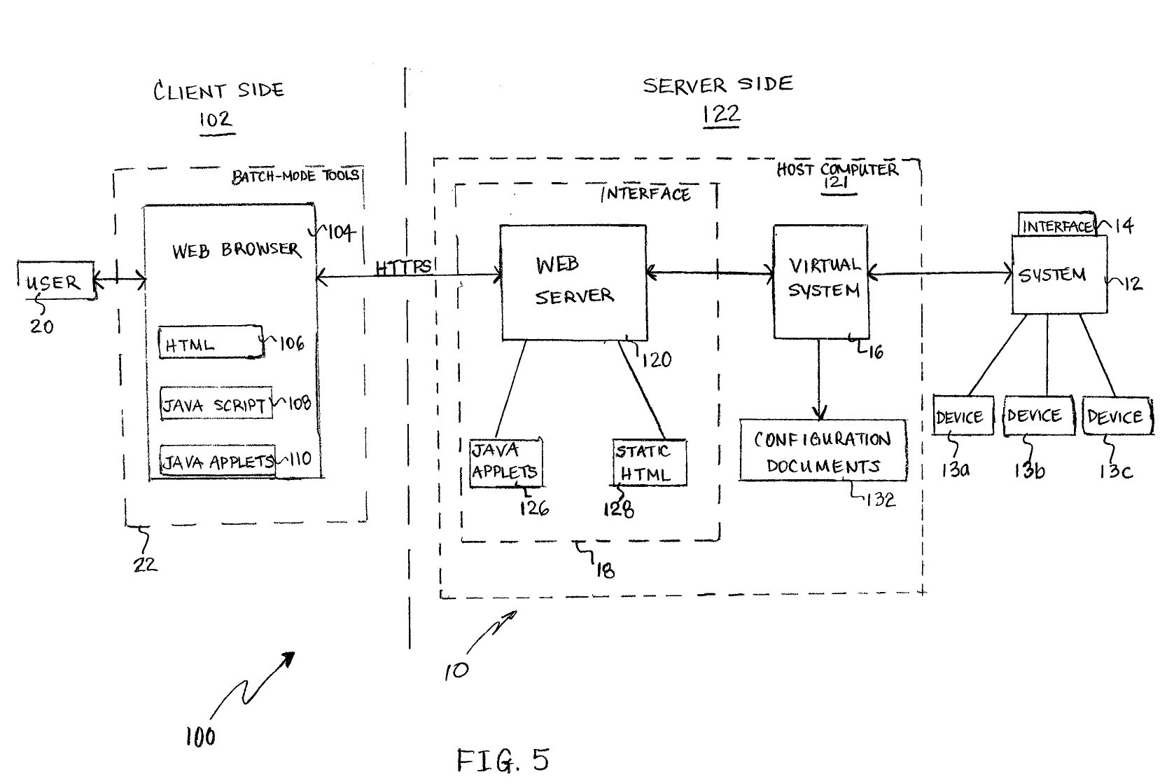

FIG. 5 provides an overall system 100 exemplifying a specific implementation of the present invention using Internet based tools and configuration instances 80. The specific modules discussed in conjunction with FIG. 5 include features that are combinations of the more general modules discussed in FIG. 3. The following mapping is provided for clarity:

(a) web browser 104—display output module 50;

(b) web server 120—parameter display module 54 and input module 52; and

(c) static HTML 128—parameter display module 54.

A client side 102 includes a web browser 104 that hosts the configuration instance 80 through a graphical user interface (GUI). The GUI is implemented using Hyper-Text Markup Language (HTML) 106, JavaScript™ 108 and Java™ Applets 110.

The configuration instance 80 is implemented as a Java servlet and accessed through a web server 120 located on a server side 122. The configuration system 10 is hosted by a host computer 121. The web server 120 accesses Java applets 126 and static HTML 128 modules to form the interface 18 of the virtual system 16. Java servlets are instantiated when the web server 120 starts and run until the web server 120 is shut down. Therefore, each Java servlet request that the web server 120 receives is forwarded to an already instantiated servlet. Also, Java servlets have the same lifetime as the web server 120.

Therefore the servlet state is persistent across multiple HTTP requests. This persistency characteristic is exploited in the present invention since transactions that are ultimately applied to the system 12 are stored in the aggregation phase 82 of the configuration instance 80. Once the application phase 84 begins, transactions are applied from the aggregation phase 82.

Communication between the client side 102 and the server side 122 occurs using Secure Hyper-Text Transfer Protocol (HTTPS) with TCP/IP connections. When the only available connection to the server side 122 is a serial cable, then RAS (Remote Access Services) is used over the serial cable to enable TCP/IP connections.

Each configuration instance 80 that is implemented in the system 100 is stored in one or more configuration documents 132. The configuration documents 132 are static files stored in extensible Markup Language (XML) format. Each configuration document 132 contains instructions to manage the configuration instance 80. More specifically, no specific knowledge of the implemented configuration instance 80 is contained in the virtual system 16 per se, but is provided by the configuration documents 132 in the present example.

Static HTML documents 128 are rendered by the web browser 104 as part of the GUI for the configuration instance 80. The static HTML documents 128 are typically documents that change infrequently or not at all, such as help files and reports on the progress of configuration instances 80. For example, referring to FIG. 4, each configuration instance 80 ultimately ends in either the completed state 90 or the cancelled state 86. Therefore, they are presented to the user 20 (at the client side 102) from the static HTML module 128.

Although the final state (complete 90 or cancelled 86) of a particular configuration instance 80 is not known until one of the states 86, 90 is reached, a URL specifying the ultimate location of the static HTML document 128 is provided to the user 20. While the configuration instance 80 is active (i.e. in aggregation 82, application 84 or queue 92 phase), its state is described in the static HTML documents 128 that resides in the location specified by the URL.

Dynamic HTML documents 106 are rendered by the web browser 104 as part of the GUI for the configuration instance 80 created by the configuration module 130. The HTML documents 106 include the necessary data pages of the GUI, which contain data fields plus the usual “NEXT”, “BACK”, “CANCEL” and “APPLY” functions.

A dynamic HTML document 106 is generated each time a servlet receives a service request that is classifies as one of the following types: (a) a “reload” of a data page; (b) a “next” data page navigation request; (c) a “back/previous” data page navigation request; (d) a “cancel” request or (d) an “apply” request as discussed previously in conjunction with FIG. 4.

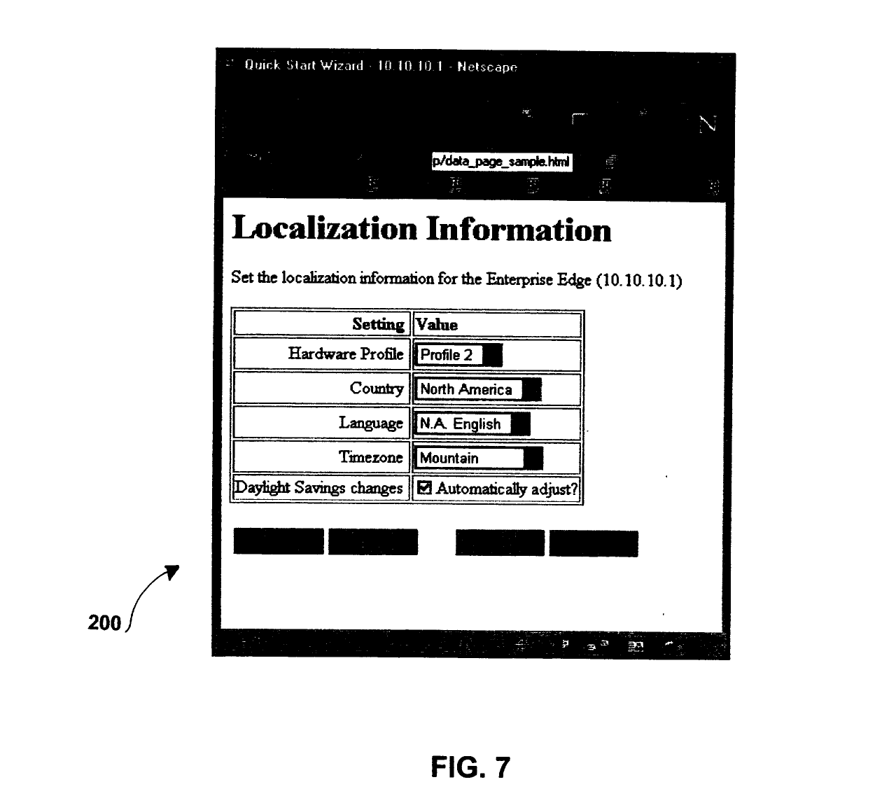

A sample data page 200 of a configuration instance 80 is shown in FIG. 7. Basic HTML fields and Java applets are used to collect data. As an example, JavaScript 108 is a scripting language that can be embedded in HTML. The JavaScript 108 is interpreted by the web browser 104 when the HTML document 106 is loaded. The data page 200 provide some client-side 102 processing. The following functions can be performed when the user 20 changes a data field in the data page 200:

(a) perform client-side 102 validation of the new value, possibly rejecting the new value;

(b) send the new value to the server 120;

(c) report rejection of the new value by the server 120;

(d) revert to the old value for the data field; or

(e) force the data page 200 to be reloaded.

The Java applets module 110 on the client side 102 provides a mechanism for sending new data values to the server 120, and communicating the server 120 reply. To communicate with the virtual system 16 in the context of a current configuration instance 80, each applet (in the Java applets module 126) includes the following information, for example: IP address; web server port number; and a unique identifier for the configuration instance 80.

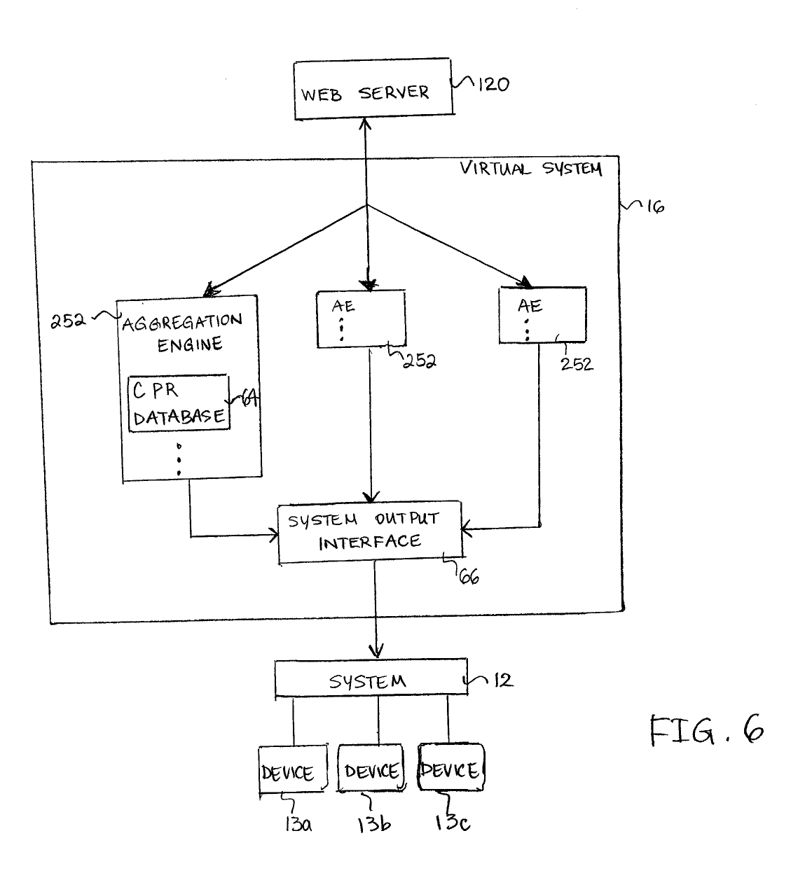

FIG. 6 provides a block diagram representation of an exemplary embodiment of the virtual system 16 for the Internet based implementation example of FIG. 5. In this example, the virtual system 16 has the following responsibilities:

(a) handle the launching of new configuration instances 80;

(b) execute the aggregation 82 and application 84 phases of configuration instances 80; and

(c) provide reporting on cancelled 86 and completed 90 configuration instances 80.

The virtual system 16 includes a plurality of aggregation engines 252 that have access to the components shown in FIG. 3 (but are not shown in FIG. 6 for simplicity). The aggregation engines 252 all interact with the system output interface module 66 for ultimate application to the system 12 as discussed in conjunction with FIG. 3.

The web server 120 has the following responsibilities: (a) provide an entry point to the virtual system 16; (b) provide an interface for launching new configuration instances 80; (c) route requests/replies between the virtual system 16 and the instances 80 of the plurality of aggregation engines 252; (d) verify that the configuration documents 132 are valid XML documents; (e) verify that the system output interface 66 can be initialized on start-up; and (f) handle expected and unexpected shutdowns of the virtual system 16.

Each aggregation engine 252 handles the aggregation phase 82 of a single configuration instance 80. Refer to FIG. 4 for details of the states and state transitions of the configuration instance 80. The aggregation engine 252 has the following responsibilities: (a) collect and verify data entered by the user 20 and (b) handle the reload/back/next/cancel/apply requests. For item (a), the data entered by the user 20 is collected via HTTP requests sent by the JavaScript 108 or a self-controlled GUI component. A limited amount of client side 102 validation is performed on each data value entered by the user 20, and this validation is replicated on the server-side 122. In certain cases (example provided below), further server side 122 validation is required.

For example, the user 20 wants to configure the system 12 by assigning “Line 151” to telephone “Set/DN 221” (e.g. device 13a). The client-side 102 verification ensures that the index of the line to assign exists within the ranges of lines (e.g. devices 13b-c) of the configured telephony system (i.e. the system 12). If we assume that Line 151 is within this range, the data update passes client-side validation and the request is sent to one of the aggregation engines 252. However, in this particular example, the request to assign Line 151 to DN 221 is subsequently rejected during server-side 122 verification because Line 151 is a PRI (Primary Rate Interface) trunk, and PRI trunks cannot be assigned to DNs.

Response to successful data update requests includes a response message string containing the following: (a) indication of success or failure of the data update; (b) indication of whether or not the data page (e.g. page 200 in FIG. 7) should be reloaded; and (c) any failure or impact messages. The response message string is not seen by the user 20, but is interpreted by the client-side 102 JavaScript 108 or self-controlling GUI component that made the request. In cases where a data update causes changes to the contents of a data page, the response to the update will indicate that the data page should be reloaded. If the page is reloaded, it will be the client-side 102 JavaScript 108 of self-controlling GUI component that instructs the web browser 104.

The reload/back/next (RBN) request of the aggregation engine 252 is a request for the HTML version of a data page of the configuration instance 80. The RBN requests are standard navigation requests, which are used to navigate the user 20 through the data pages of the configuration instance 80. The RBN request is made by the web browser 104 and the HTML document 106 returned is rendered in that web browser 104. The HTML document 106 is generated by the aggregation engine 252.

The cancel request of the aggregation engine 252 is similar to the RBN data page navigation request and is made by the web browser 104. The response is a dynamic HTML page 106 that is rendered in the requesting web browser 104. The handling of the cancel request differs from the handling of the RBN data page navigation requests in two ways: (a) the dynamic HTML document 106 sent back is not a representation of a data page; and (b) the configuration instance 80 is cancelled. When a cancel request is received, the aggregation engine 252 cancels the configuration instance 80 and returns an HTML document 106 indicating that the configuration instance 80 has been cancelled.

The apply request of the aggregation engine 252 is also made by the web browser 104 and the response is a dynamic HTML page 106 that is rendered in the requesting web browser 104. The handling of the cancel request differs from the handling of the RBN data page navigation requests in two ways: (a) the dynamic HTML document 106 sent back is not a representation of a data page; and (b) the configuration instance 80 is applied. When an apply request is received, the aggregation engine 252 returns an HTML document 106 detailing the data changes that will be applied to the system 12. Responsibility for the configuration instance 80 is then passed to the system output interface 66.

The virtual system 16 includes a series of trees 280A-C (shown in FIG. 8) that mirrors the actual state of the system 12 when the information currently aggregated (in the aggregation state 82) is applied to the system 12. The virtual system 16 serves as a storage mechanism for the aggregated data and to “act” as the system 12.

In tree 280A a selection for option B is made from list C. After pool A is selected, pool D is added to list C (i.e. provide another option for option B when pool A is selected) as shown in tree 280B. Pool D is selected for option B at tree 280C. When “apply” 38a is selected (see FIG. 2; transition from collection 32 to application 34) changes to the system 12 are applied in order [1 then 2], which ensures that option B=pool D is applied after pool D is added to list C. This occurs because the virtual system 16 mimics the interface 14 (e.g. OAM interface) behavior of the actual system 12, which effectively “forces” the selections to be made in the correct order.

The virtual system 16 filters configuration options. For example, market profile affects what trunk types are available in configuring a telephony system. If the market profile is U.K., then only certain trunk type options will be presented to the user 20 for selection. As a further example, when a DN has a non-blank “Forward no answer” value, the “After rings:” option is presented to the user 20. If this value is blank, then the system 16 does not present the “After rings” option since if calls are not forwarded a setting for the number of rings to wait before forwarding does not apply.

If the virtual system 16 receives a value for an option, and then that option is later invalidated (i.e. made not visible) then the value is maintained in the virtual system 16. If the option is not visible then the value is not applied (during the application phase 84) to the system 12.

The set of options that are presented to the user 20 is the union of the set of options that the virtual system 16 allows and the set of options that the configuration document 132 provides for a particular data item. One or both may simply specify “all”, which means that only the filter specification will limit what the user 20 may submit.

A document in the configuration documents module 132 can include assumptions. For example, refer to sample structure S1.

### Sample Structure S1

Configuration Instance 80

Title

Page 1

Data 1—valid options, filter

Data 2—valid options, filter

Data 3—valid options, filter

Page 2

Data 4—valid options, filter

Decision 1

Value 1

Data 5—valid options, filter

Data 6—valid options, filter

Value 2

Data 7—valid options, filter

Value 3

Data 8—valid options, filter

Page 3

Data 9—valid options, filter

Data 10—valid options, filter

Data 11—valid options, filter

Decision 2

Value 1

Page 4

Data 12—valid options, filter

Data 13—valid options, filter

Value 2

Page 5

Data 14—valid options, filter

Data 15—valid options, filter

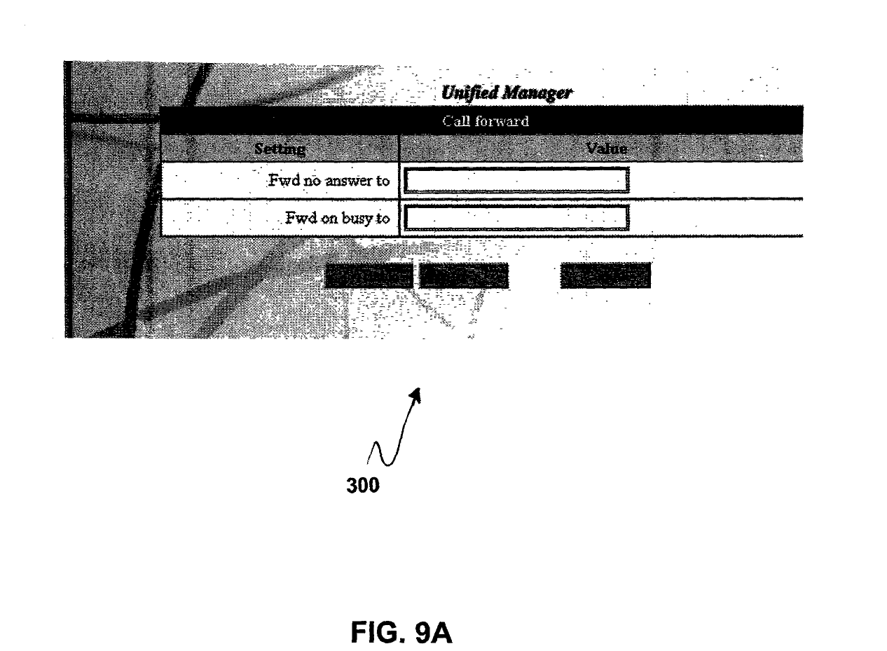

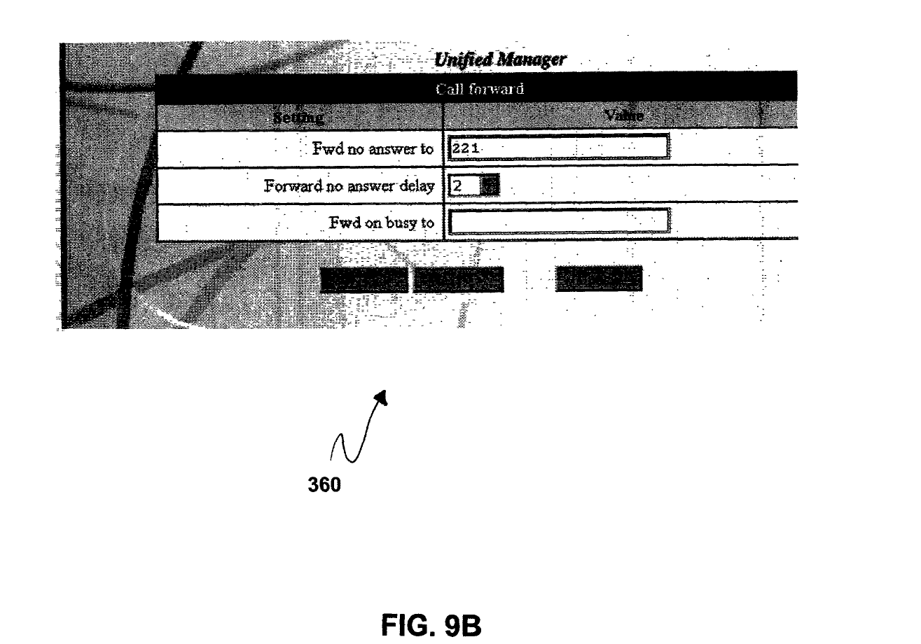

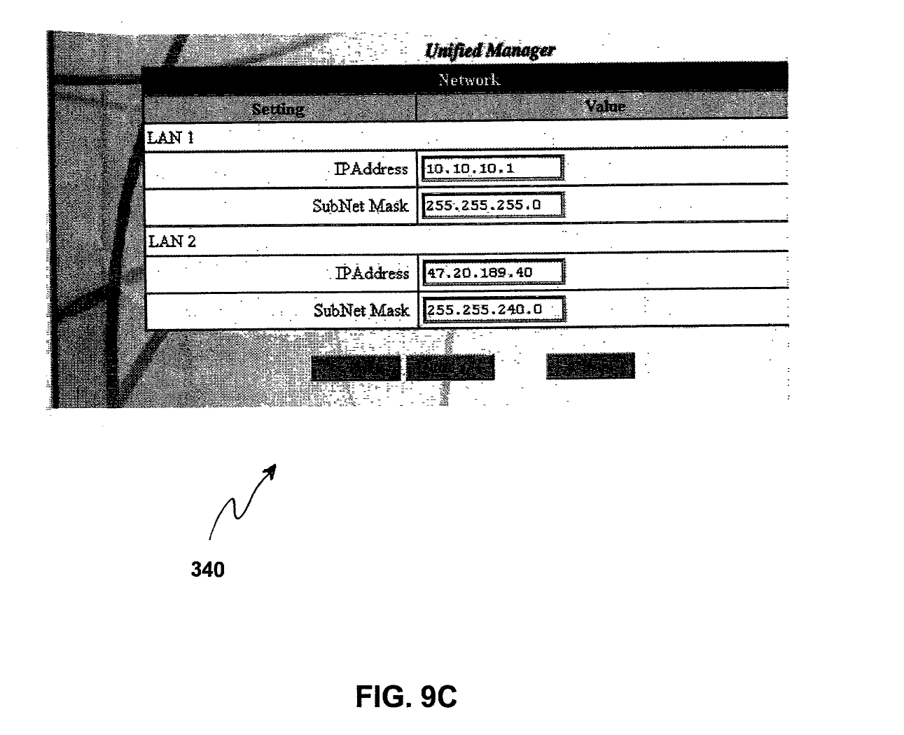

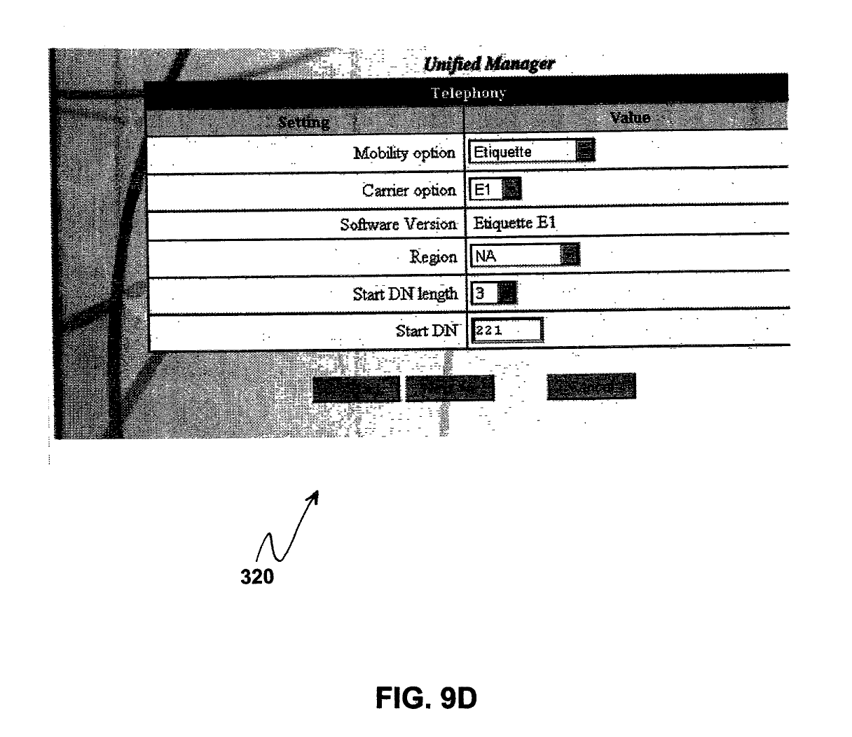

FIG. 9A illustrates a screen shot 300 of a particular configuration instance 80 for call forward settings. The first setting, “Forward no answer to” has a blank value, which indicates that unanswered calls should not be forwarded. When unanswered calls are not forwarded, a setting for the ring delay before forwarding calls (“Forward no answer delay”) has no purpose here. The tool 22 that produces the window in screen shot 300, requested from the virtual system 16 if the “Forward no answer delay” setting is visible in the current configuration. The virtual system 16 answered “no”, so the tool 22 did not display the “Forward no answer delay” setting.

In FIG. 9B a screen shot 360 of another configuration instance 80 when a value for the “Forward no answer to” setting is provided by the user 20. The screen shot 320 shows three call forward settings. “Forward no answer to” has a non-blank value of “221”, implying that call should be forwarded. A “Forward no answer delay” setting now has purpose. The client side 102, through the web server 120, polled the virtual system 16 to determine if the “Forward no answer delay” setting is visible in the current configuration. In this example, the virtual system 16 answered “yes”, so the client side 102 web browser 104 displays the “Forward no answer delay” setting.

When the virtual system 16 applies these two values to the system 12, the correct order is used. This is accomplished because the virtual system 16 has the knowledge to “hide” the “Forward no answer delay” setting while “Forward no answer to” was blank (in the same manner the actual system 12 would). By mimicking the actual system 12, the virtual system 16 ensures that it can eventually apply the setting in the correct order.

FIG. 9C is a screen shot 340 showing four settings relating to IP networking: LAN 1 settings for IP address and subnet mask and LAN 2 settings for IP address and subnet mask. If these settings were established directly to the system 12 a system reboot would be required, which would impede the user 20 from making further changes until the reboot is complete. In contrast, in the configuration system 10 of the present invention, the settings and the required reboot invocation are applied to the virtual system 16. The user 20 can then continue to process other configuration instances 80, since the settings have been stored in the virtual system 16 and not applied/invoked on the actual system 12.

The user 20 can advance to a next page 320 shown in FIG. 9D and continue with another instance 80 without waiting for a reboot to occur. In practice, the wait time factor can be significant. For example, for a telephony switch configuration, a list of valid “regions” depends on the “core software version” that is selected. Therefore, the user 20 must selection a “core software version” before a list of “regions” is presented. In some systems, it can take over 30 minutes to select a “core software version” before a list of valid “regions” can be presented. Using the configuration system 10 of the present invention, it takes less than 10 seconds. Therefore, the user 20 can make the “core software version” selection, and then immediately make a “region” selection. The user 20 does not have to wait and further the user 20 can change the “core software version” setting again without incurring additional waiting time.

A further example of the use of the configuration system 10 of the present invention is provided in the sequence diagrams of FIGS. 10A-10D in relation to banking systems.

A bank wishes to provide an Automated Teller Machine (ATM) 400, which performs customer transactions and inquiries, as if that ATM were connected directly to a Central Banking System (CBS) 410. However, due to various system constraints the ATM 400 cannot maintain an open connection to the CBS 410 while serving the customer/user 20. Examples of possible constraints include:

1. A limitation in the number of open sessions the CBS 410 can maintain at one time. It is inefficient for the ATM 400 to maintain an open session with the CBS 410 while waiting for customer 20 input.

2. A long delay in establishing connections with the CBS 410. It is inefficient to open a new connection to perform each transaction or inquiry.

3. Minimize the number of redundant and failed transactions. For example, it would be preferable to avoid transactions that would fail, and avoid transactions that would “undo” each other.

The configuration system 10 of the present invention is implemented as a virtual central bank system (VCBS) 420 that is instantiated in the ATM 420 (shown separately in FIGS. 10A-10D for illustration purposes). The interface of the CBS 410 is complex because certain settings and operations have effects on other settings or operations. Some examples of this are:

1. A withdrawal operation could fail if an account lacks sufficient funds.

2. A withdrawal operation could fail if a previous transaction removed funds, even if there were sufficient funds at the start of the session.

3. A bill payment could fail if the selected payee doesn't exist.

4. A withdrawal may succeed, because a previous transaction added funds, even though there weren't sufficient funds at the start of the session.

The user-customer 20 interacts with the ATM 400 that interacts with the VCBS 420, which resides on the ATM 400. Referring to FIG. 1, the ATM 400 acts as the tool 22, the VCBS 400 is the configuration system 10 and the system 12 and interface 14 is the CBS 410.

The VCBS 420 processes transactions (collected by the ATM 400) as if it were the actual CBS 410. When the customer 20 is satisfied with a set of the banking transactions, the ATM 400 applies the transactions (in batch-mode) to the CBS 410. Since the VCBS 420 mimics the CBS 410, the VCBS 420 ensures that the transactions it applies will be accepted.

Consider a customer 20 with the following starting parameters:

(a) Savings account: $200 balance, no overdraft allowance

(b) Line of credit account: $800 balance, $1000 limit

(c) Car loan: $4000 balance

(d) Bill payees: Visa, Pacific Bell

(e) Customer's deposits are put on a 3 day hold

An example of the customer's 20 use-case scenario is provided below.

### ATM USE-CASE EXAMPLE

1. The customer 20 inserts a card (not shown) into the ATM 400 and enters appropriate security code (e.g. personal identification number (PIN) etc.).

2. The ATM 400 instantiates the VCBS 420 (with the customer's 20 card # and PIN) to handle the session.

3. The VCBS 420 establishes a temporary short term connection to the CBS 410 to download the customer's 20 details (as provided above).

4. The customer 20 selects a bill payment option.

5. The ATM 400 provides the list of payees for the customer 20 from the VCBS 420, and displays it on a screen (not shown) of the ATM 400.

6. The customer 20 determines that “SGE Hydro” is not on the payee list, so the customer 20 proceeds to add “SGE Hydro” to the payee list.

7. The ATM 400 makes the payee addition (SGE Hydro) to the VCBS 420.

8. The customer 20 selects a bill payment option.

9. The ATM 400 provides the list of payees for the customer 20 from the VCBS 420, and displays it on the screen of the ATM 400. The payee “SGE Hydro” is now included in the list of payees.

10. The customer 20 chooses to pay SGE Hydro $50 from the savings account.

11. The ATM 400 forwards the “pay SGE Hydro $50 from savings” request to the VCBS 420.

12. The customer 20 chooses to withdrawal $200 from the savings account.

13. The ATM 400 forwards the “withdrawal $200 from savings” request to the VCBS 420. The request is rejected.

14. The ATM 400 makes a request for the balance of the savings account. The balance is $150.

15. The ATM 400 reports to the customer 20 that the transaction failed because there is only $150 in the savings account.

16. The customer 20 chooses to withdrawal $150 from the savings account.

17. The ATM 400 forwards the “withdrawal $150 from savings” request to the VCBS 420. The request is accepted, although the ATM 400 does not output the cash at this time.

18. The customer 20 chooses to transfer $300 from the line of credit (LOC) account to the savings account.

19. The ATM 400 forwards the “transfer $300 from LOC to savings” request to the VCBS 420. The request is rejected.

20. The ATM 400 makes a request for the balance of the LOC account. The balance is $800.

21. The ATM 400 makes a request for the credit limit of the LOC account. The credit limit is $1000.

22. The ATM 400 reports to the customer 20 that the transaction failed because there is only $200 credit available in the LOC account.

23. The customer 20 chooses to transfer $200 from the Line of credit account to the savings account.

24. The ATM 400 forwards the “transfer $200 from LOC to savings” request to the VCBS 420. The request is accepted.

25. The customer 20 chooses to change (see step 17) the withdrawal value from savings to $50.

26. The ATM 400 makes a request to “deposit $100 to savings” request to the VCBS 420. The request is accepted, although the ATM 400 does not accept a cash deposit at this time.

27. The customer 20 chooses to pay Visa $280 from the savings account.

28. The ATM 400 forwards the “pay Visa $280 from savings” request to the VCBS 420.

29. The customer 20 requests the balance of the savings account.

30. The ATM 400 makes a request (to the VCBS 420) for the balance of the savings account. The balance is $20.

31. The ATM 400 reports to the customer 20 that the balance of the savings account is $20.

32. The customer 20 is satisfied with the transactions and requests that the ATM 400 apply them to the CBS 410.

33. The ATM 400 forwards the “apply” (see state diagram of FIG. 2) request to the VCBS 420.

34. The VCBS 420 establishes a connection to the CBS 410 and applies the collected transactions.

35. The ATM 400 informs the customer 20 that the application of the transactions were successful.

36. The ATM 400 provides $50 cash for the customer 20.

The end result of the customer-user 20 session is:

(a) “SGE Hydro” was added to the payee list;

(b) “SGE Hydro” was paid $50;

(c) Visa was paid $280;

(d) the line of credit account balance was increased to $1000;

(e) the savings account balance was reduced to $20; and

(f) $50 was provided by the ATM 400 to the customer 20.

Another advantage of the configuration system 10 is exemplified in the three day hold on deposits setting of the banking example. The user 20 modified the $150 withdrawal to $50. If the $150 withdrawal had taken place immediately, the user 20 would have had to deposit $100. This would have been subject to a three day hold. More importantly, it would have resulted in two transactions. In contrast, the VCBS 420 simply modified an existing (queued) transaction, to get the same net effect of two complete transactions.

Referring to the configuration system 10 state diagram in FIG. 2, steps 4 to 31 represent the collection operation 32 (including the get attribute 36a, set attribute 36b, get options 36c, and get visibility 36d functions) and steps 32-34 represent the “apply” function 38a to the application operation 34. The “apply completed” function 38b is represented by step 35.

1. An apparatus for configuring a plurality of parameters of a target system having an interface, the apparatus comprising:
(a) a virtual system hosted on a computer, said virtual system including:
(i) a collection tool supporting the interface of the target system, wherein changes to the plurality of parameters are applied to the virtual system; and
(ii) an application tool for applying the changes of the plurality of parameters in a batch-mode to the target system; and
(b) an interface to the virtual system interacting with the collection tool of the virtual system to enable changes to the plurality of parameters to be communicated to the collection tool, wherein the changes to the plurality of parameters are cumulated prior to application to the target system by the application tool.

2. The apparatus of claim 1, wherein the interface includes means for querying the virtual system to determine if a selected one of the plurality of parameters is visible on the computer and if the selected one of the plurality of parameters is visible further including means for obtaining a value of the selected one of the plurality of parameters and a valid option specification to permit manipulation of the value by the collection tool.

3. The apparatus of claim 1, wherein the collection tool includes a display output and an input module, said display output presents a representation of the plurality of parameters of the target system.

4. The apparatus of claim 3, further comprising a parameter display module in communication with the display output and a display formulation module in communication with the parameter display module to provide content for the representation of the plurality of parameters for the target system.

5. The apparatus of claim 4, further comprising a parameter selection acceptor in communication with display formulation module for receiving input data from the input module

6. The apparatus of claim 5, further comprising a configuration data file creator in communication with the parameter selection acceptor to execute a given configuration when the input data is a command to execute.

7. The apparatus of claim 6, further comprising a configuration parameters relations database accessible by the display formulation module for determining related parameters, selected from the plurality of parameters, that require configuration in response to changes to the plurality of parameters.

8. The apparatus of claim 7, wherein the configuration parameters relations database includes a hierarchical list of the plurality of parameters according to relations to each other.

9. The apparatus of claim 7, wherein the configuration parameters relations database includes a categorical relations table f or defining the plurality of parameters.

10. The apparatus of claim 8, further comprising a configuration data file creator communicating with the parameter selection acceptor and the parameter values database such that when the command to execute the given configuration is received the display formulation module detects the end of the hierarchical list in the configuration parameters relations database to form a data file for configuration of the target system.

11. The apparatus of claim 10, further comprising a system output interface in communication with the configuration data file creator to enable configuration of the target system.

12. A computer-readable medium having stored thereon computer executable instructions for configuring a plurality of parameters of a target system having an interface performing steps comprising:
(a) providing a virtual system to emulate behavior of the target system as defined by the interface of the target system;
(b) collecting and validating at least one change to the plurality of parameters by application to the virtual system; and
(c) applying the at least one change of the plurality of parameters in a batch-mode to the target system.

13. The computer-readable medium of claim 12, further comprising the step of providing a virtual interface to the virtual system, said virtual interface is representative of the interface of the target system.

14. The computer-readable medium of claim 13, wherein step (b) includes: querying the virtual system to determine if a selected one of the plurality of parameters is visible to the virtual interface.

15. The computer-readable medium of claim 14, further comprising: obtaining a value of the selected one of the plurality of parameters and a valid option specification.

16. The computer-readable medium of claim 15, further comprising: making the value of the selected one of the plurality of parameter visible to the virtual interface to permit manipulation of the value.

17. In a computer system, a method of creating a program using a graphical user interface for configuring a plurality of parameters of a target system having an interface, the method comprising the steps of:
(a) providing a virtual system to emulate behavior of the target system as defined by the interface of the target system;
(b) collecting and validating at least one change to the plurality of parameters by application to the virtual system; and
(c) applying the at least one change of the plurality of parameters in a batch-mode to the target system.

18. The method of claim 17, further comprising the step of providing a virtual interface to the virtual system, said virtual interface is representative of the interface of the target system.

19. The method of claim 18, wherein step (b) includes: querying the virtual system to determine if a selected one of the plurality of parameters is visible to the virtual interface.

20. The method of claim 19, further comprising: obtaining a value of the selected one of the plurality of parameters and a valid option specification.

21. The method of claim 20, further comprising: making the value of the selected one of the plurality of parameter visible to the virtual interface to permit manipulation of the value.

22. A configuration apparatus for collection and batch-mode application of transactions defined by a plurality of settings for a target system having an operation, administration and maintenance (OAM) interface, the apparatus comprising:
(a) a virtual system having a host computer programmed to emulate functionality of the target system;
(b) a collection system interacting with the virtual system for establishing values for the plurality of settings; and
(c) an application system for applying the established values for the plurality of settings to the target system in a batch-mode.

23. The configuration apparatus of claim 22, further comprising a virtual interface to emulate the OAM interface of the target interface, said virtual interface interacting with the virtual system for querying the virtual system to determine if a selected one of the plurality of settings is visible on the host computer and if the selected one of the plurality of settings is visible further including means for obtaining a value of the selected one of the plurality of settings and a valid option specification to permit manipulation of the value by the collection system.

24. The configuration apparatus of claim 22, wherein the collection system includes a display output and an input module, said display output presents a representation of the plurality of settings of the target system.

25. The configuration apparatus of claim 24, further comprising a setting display module in communication with the display output and a display formulation module in communication with the setting display module to provide content for the representation of the plurality of settings for the target system.

26. The configuration apparatus of claim 25, further comprising a setting selection acceptor in communication with display formulation module for receiving input data from the input module

27. The configuration apparatus of claim 26, further comprising a configuration data file creator in communication with the setting selection acceptor to execute a given configuration when the input data is a command to execute.

28. The configuration apparatus of claim 27, further comprising a configuration settings relations database accessible by the display formulation module for determining related settings, selected from the plurality of settings, that require configuration in response to changes to the plurality of settings.

29. The configuration apparatus of claim 28, wherein the configuration settings relations database includes a hierarchical list of the plurality of settings according to relations to each other.

30. The configuration apparatus of claim 29, further comprising a configuration data file creator communicating with the setting selection acceptor and the setting values database such that when the command to execute the given configuration is received the display formulation module detects the end of the hierarchical list in the configuration settings relations database to form a data file for configuration of the target system.

31. The apparatus of claim 30, further comprising a system output interface in communication with the configuration data file creator to enable configuration of the target system.

32. A configuration method for collection and batch-mode application of transactions defined by a plurality of settings for a target system having an operation, administration and maintenance (OAM) interface, the method comprising the steps of:
(a) constructing a virtual representation in a software model of the target system;
(b) providing collection tools to interact with the virtual representation of the target system to establish values for the plurality of settings; and
(c) applying the established values for the plurality of settings to the target system in a batch-mode.

33. The configuration method of claim 32, further comprising the step of providing a virtual interface to the virtual representation, said virtual interface emulating the OAM interface of the target system.

34. The configuration method of claim 33, wherein step (b) includes: querying the virtual representation to determine if a selected one of the plurality of settings is visible to the virtual interface.

35. The configuration method of claim 34, further comprising: obtaining a value of the selected one of the plurality of settings and a valid option specification.

36. The configuration method of claim 35, further comprising: making the value of the selected one of the plurality of parameter visible to the virtual interface to permit manipulation of the value.
